(19) United States
(12) Patent Application Publication
(10) Pub. No.: US 2017/0154125 A1
(43) Pub. Date: Jun. 1, 2017

(54) AUTOCOMPLETE SUGGESTIONS BY CONTEXT-AWARE KEY-PHRASE GENERATION

(71) Applicant: International Business Machines Corporation, Armonk, NY (US)

(72) Inventors: Karthik Balakrishnan, White Plains, NY (US); David James Frank, Yorktown Heights, NY (US); Linder Barry Paul, Hastings-on-Hudson, NY (US)

(21) Appl. No.: 14/954,423

(22) Filed: Nov. 30, 2015

(51) Int. Cl. G06F 17/30; G06F 3/0482; G06F 3/0484; G06F 17/27

(52) U.S. Cl. CPC G06F 17/30973; G06F 17/2705; G06F 3/0482; G06F 3/04842

(57) ABSTRACT

A method, device or system can include a key-word generator receiving contextual input, parsing the contextual input and generating a plurality of suggestions based on the contextual input, and a display receiving the plurality of suggestions from the key-word generator. The device or system can also include an autocomplete suggestion generator that receives the plurality of suggestions generated by the key-word generator, a search input, a second set of suggestions generated using another method than the key-word generator to provide autocomplete suggestions displayed on the display.

### BACKGROUND OF THE INVENTION

Field of the Invention

The disclosed invention relates generally to a method and apparatus to generating autocomplete suggestions, and more particularly, but not by way of limitation, relating to a method and apparatus for generating search autocomplete suggestions based on contextual input.

Description of the Related Art

In order to increase the efficiency and accuracy of input, a feature of auto-complete has been used. Autocomplete is a feature in which there is a prediction of the remaining portion of a word, a plurality of words, phrase, or sentence a user is typing. For example, when a portion of a word or phrase is entered, an auto-completion program provides suggestions of completing the word or phrase. Then a user may select one of the suggested options or enter their own manual entry.

Traditional search autocomplete suggestions are based on simple word completions using a dictionary search or on previous search/browse history. Therefore, an auto-completion program can reduce the necessary keystrokes to complete a word or phrase which increase data input efficiency. However, currently, the accuracy of the current programs is limited where they provide many unrelated terms and phrases.

Therefore, it is desirable to provide an improved version of auto-completion that can be more accurate and that can further increase efficiency.

### SUMMARY OF INVENTION

In view of the foregoing and other problems, disadvantages, and drawbacks of the aforementioned background art, an exemplary aspect of the disclosed invention provides a system, apparatus and method of providing for generating search autocomplete suggestions based on contextual input.

One example aspect of the disclosed invention provides a mobile device including a key-information generator receiving contextual input, parsing the contextual input and generating a plurality of suggestions and phrases based on the contextual input, and a display receiving the plurality of suggestions from the key-information generator.

The mobile device can also include an autocomplete suggestion generator that receives the suggestions generated by the key-information generator, a search input, key-information generated using another method than the key-information generator to provide autocomplete suggestions displayed on the display. The mobile device can also include a processor, a computer readable medium storing a program executable by the processor, including the key-information generator. Upon a trigger, a list of key-words is generated by the key-information generator based on analysis of contextual information. The contextual information includes audio data for a time frame in a range of 5 seconds to 2 minutes. The contextual information includes data from sensors, the data including location information, environmental condition, and health information. The display provides a search bar drop-down, displaying a list of suggestions which include those based on key-phrase generation. The autocomplete suggestion generator can receive input from the key-information generator, another key-phrase generator and a search input to generate a plurality of autocomplete suggestions.

Another example aspect of the disclosed invention can include a key-word generator receiving contextual input, parsing the contextual input and generating a plurality of key-words based on the contextual input, and a mobile device including a display receiving the plurality of key-words and key-phrases from the key-word generator. The search system can also include autocomplete suggestion generator that receives the key-words generated by the key-word generator, a search input, key-phrases generated using another method than the key-word generator to provide autocomplete suggestions displayed on the display.

The autocomplete suggestion generator and autocomplete generator can be implemented in a cloud computing system. The search system can include a computer readable medium storing a program executable by a processor, including the key-phrase generator being implemented in a cloud computing system. Upon a trigger, a list of key-words is generated by the key-word generator based on analysis of contextual information. The contextual information includes audio data for a time frame in a range of 5 seconds to 2 minutes. The contextual information includes data from sensors, the data including location information, environmental condition, and health information. The display in the mobile device provides a search bar drop-down, displaying a list of suggestions which include those based on key-phrase generation.

Yet another example aspect of the disclosed invention includes a method of search including receiving, by a key-word generator, contextual input, parsing the contextual input and generating a plurality of key-words based on the contextual input, and receiving and displaying the plurality of key-words and key-phrases from the key-word generator. The search method can also include receiving, by an autocomplete suggestion generator, the key-words generated by the key-word generator, a search input, key-phrases generated using another method than the key-word generator to generator autocomplete suggestions displayed on the display of the mobile device.

The method can also include storing a program on a computer-readable medium executable by a processor, including the key-phrase generator. Whereupon a trigger, a list of key-words is generated by the key-word generator based on analysis of contextual information. The contextual information includes data from sensors, the data including location information, environmental condition, and health information, and the display provides a search bar drop-down, displaying a list of suggestions which include those based on key-phrase generation.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

It is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF DRAWINGS

The exemplary aspects of the invention will be better understood from the following detailed description of the exemplary embodiments of the invention with reference to the drawings.

FIG. 1 shows an example embodiment of key-phrase generation.

FIG. 2 shows an example embodiment of key-phrase generation in the clouds.

FIG. 3 illustrates another example embodiment of key-phrase generation.

FIG. 4 illustrates an example of contextual input capture.

FIG. 5 shows an example of a user trigger.

FIG. 6 illustrates another example of a user trigger.

FIG. 7 illustrates an example of a user entering an input in a search bar.

FIG. 8 illustrates another example of a user entering input in a search bar.

FIG. 9 illustrates an exemplary hardware/information handling system for incorporating the exemplary embodiment of the invention therein.

FIG. 10 illustrates a signal-bearing storage medium for storing machine-readable instructions of a program that implements the method according to the exemplary embodiment of the invention.

FIG. 11 depicts a cloud computing node according to an embodiment of the present invention;

FIG. 12 depicts a cloud computing environment according to an embodiment of the present invention; and

FIG. 13 depicts abstraction model layers according to an embodiment of the present invention.

### DETAILED DESCRIPTION OF A PREFERRED EMBODIMENTS

The invention will now be described with reference to the drawing figures, in which like reference numerals refer to like parts throughout. It is emphasized that, according to common practice, the various features of the drawing are not necessary to scale. On the contrary, the dimensions of the various features can be arbitrarily expanded or reduced for clarity. Exemplary embodiments are provided below for illustration purposes and do not limit the claims.

As mentioned previously, traditional search autocomplete suggestions are based on simple word completions using a dictionary search or on previous search/browse history. Search autocomplete suggestion accuracy can be improved by enabling context-aware suggestions.

One method of generating context, for example, is to record audio of user conversations, and performing key-wording and contextualization of the conversation in a time frame just prior to a user search is initiated.

Example embodiments are proposed for a method and apparatus for generating search autocomplete suggestions based on active listening of conversation prior to the search. Other types of contextual input can be used as shown in the following. With increased computing bandwidth and higher power efficiency of mobile devices (e.g., mobile phones, tablets, etc.), more complex functions can be performed.

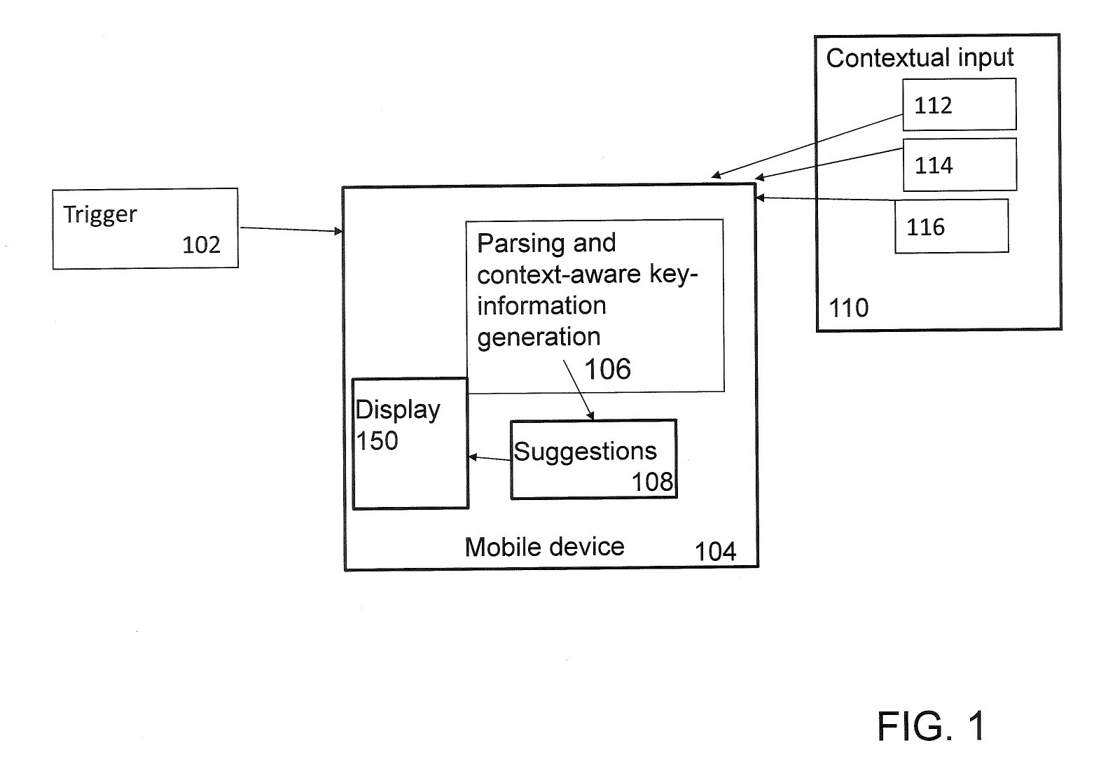

Referring to FIG. 1, a trigger action 102 on the mobile device 104 is performed. For example, the trigger 102 can be opening a search bar, activating an application, turning the mobile device 104 on, or picking up the mobile device 104. Therefore, the trigger 102 can be a user performing the above examples or it can be another device sending a trigger signal. The mobile device 104 can be, for example, mobile phone, tablet, laptop, wearable computing device such a watch, clothing based computing device, or any type of mobile computing device. Alternatively, the mobile device 104 could instead be stationary, such as a workstation, desktop computer, etc.

Upon the user trigger 102, a list of key-words (or other searchable information) is generated based on the analysis of contextual information 110 by parsing and key-information generation module 106. The time frame can be, for example, 5 seconds to 2 minutes. The time frame could be less than 5 seconds or greater than 2 minutes depending on the contextual input. The mobile device 104 at the parsing and key-information generation module 106 parses the contextual input from the contextual input unit 110 and generates suggestions 108 that are outputted to the display 150. The suggestions 108 can be any type of searchable context such as words, phrases, images, videos, direct search of sensory data, etc. The parsing and key-information generation module 106 can be implemented in software or hardware in the mobile device 104. The key-information generation can also be enabled in the clouds in examples provided later in the disclosure.

The contextual input 110 can be, for example, active listening 112, or other sensory data. For example, other sensory data can be location based information 114 from, for example, Global Positioning System (GPS) data or other location based information. The sensor data from sensor 116 can also include health based information of the user provided by a sensor on the user, such as heart rate, activity, etc. Other sensory data, can be certain other environment based sensory information that provided on a sensor 116, such as temperature, movement, humidity, etc. Various other sensory data can be inputted from either sensors on the mobile device 104 or sensors 116 that are located outside the mobile device 104. The sensors 116 can provide, for example, the sensory information wirelessly to the mobile device 104 or through a wired connection.

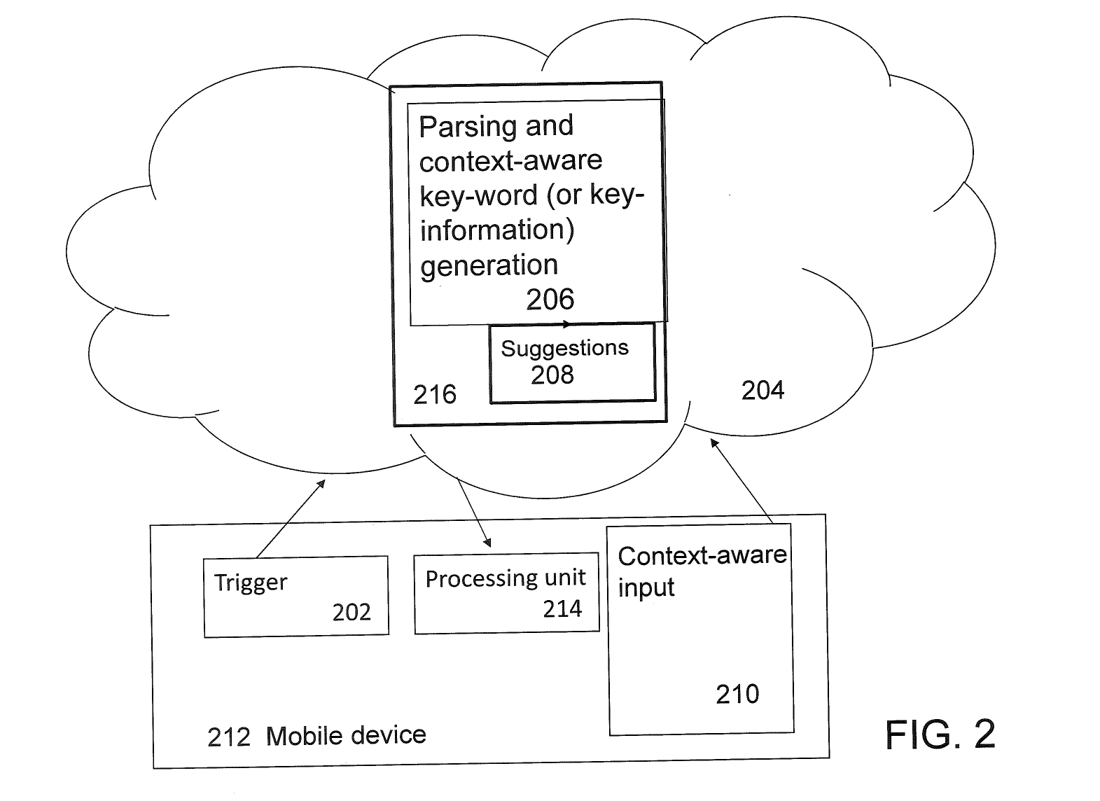

Referring to FIG. 2, the parsing and context-aware key-word (or key-information) generation module 206 can be in the clouds 204, in, for example, a virtual server or other cloud-based unit 216. A trigger module 202 can send a search term to the clouds 204, where the key-word generation unit 206 would parse the contextual input 210 and generate suggestions 208 including context-aware key-phrases. The suggestions 208 can be any type of searchable context such as words, phrases, images, videos, direct search of sensory data, etc. For example, a client computer or mobile device 212 including a processing unit 214 can control the trigger 202 and context-aware input 210, or the trigger input 202 can be manually provided from user directly or through an input device connected to the client computer or mobile device 212.

Therefore, a trigger action 202 can be sent to the virtual server 216 from a user performing the trigger action 202 at the mobile device 212. For example, the trigger 202 can be an input to open a search bar, activating an application, turning the virtual server 216 on, or a user sending a trigger input 202 to the virtual server 216 from the mobile device 212. Therefore, the trigger 202 can be a user performing the above examples or it can be another device sending a trigger input signal. The mobile device 212 can be, for example, mobile phone, tablet, laptop, wearable device such as a watch or clothing based computer, or any other type of mobile computing device. The mobile device 212 can be switched to a device that is not mobile, such as a stationary computer, workstation, etc.

Upon the user trigger 202 via the mobile device 212, a list of key-words is generated based on the analysis or parsing of contextual information 210 through the parsing and context-aware key-word generation module 206 based in the clouds 204. The time frame can be, for example, a few seconds to a few minutes, such as 5 seconds to 2 minutes. The time frame could be less than 5 seconds or greater than 2 minutes depending on the contextual input or other factors. The parsing and context-aware key-word generation module 206 analyzes the contextual input from the contextual input unit 210 and generates suggestions 208. The parsing and context-aware key-word generation module 206 can be implemented in the clouds 204 in a virtual server 216 or other virtual computing device.

The contextual input 210 can be for example, active listening, or other sensory data. For example, other sensory data can be location based information from, for example, Global Positioning System data or other location based information. Other sensory data, can be certain other environment based sensory information that provided on a sensor, such as temperature, movement, humidity, etc in the mobile device 212 or other device external to the mobile device 212. Various other sensory data can be inputted from either sensors on the mobile device 212 or sensors that are located outside the mobile device 212. The sensors can provide, for example, the sensory information wirelessly to the virtual server 216 or through a wired connection.

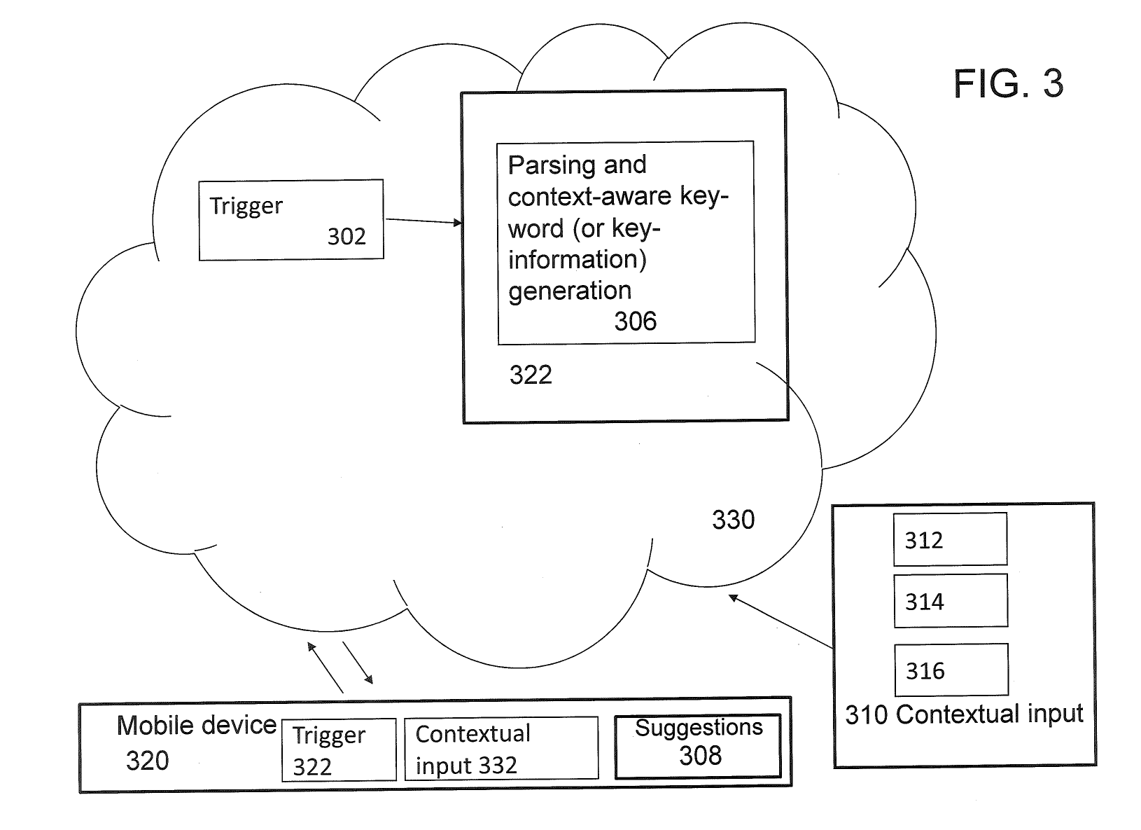

In another example, referring to FIG. 3, a trigger action 302 can be performed in the clouds 330 separate from a cloud-based server 322, or in the cloud-based server 322. For example, the trigger 302 can be an input to open a search bar, activating an application, turning the cloud-based server 322 on, or a user sending a trigger input 322 to the cloud-based server 322 through the mobile device 320. Therefore, the trigger 322 can be a user performing the above examples from the mobile device 320 or it can be another device sending a trigger input signal. The mobile device 320 can be, for example, mobile phone, tablet, laptop, wearable device or any type of mobile computing device. A stationary computing device can also be used instead of the mobile device 320.

Upon the user trigger via a cloud-based trigger 302 or mobile device trigger 322, a list of key-words is generated based on the analysis or parsing of contextual information 310 through the parsing and context-aware key-word generation module 306. The time frame can be, for example, a few seconds to a few minutes, such as 5 seconds to 2 minutes. The time frame could be less than 5 seconds or greater than 2 minutes depending on the contextual input or other factors. The parsing and context-aware key-word (or key-information) generation module 306 analyzes the contextual input from the contextual input unit 310 and generates suggestions 308. The suggestions 308 can be any type of searchable context such as words, phrases, images, videos, direct search of sensory data, etc. The parsing and context-aware key-word generation module 306 can be implemented in software in the clouds 330 or in a separate hardware connected to the clouds 330.

The contextual input can be from a first contextual input module 332 in the mobile device 320 and/or a second contextual input module 310 that is separate from the mobile device 320. The second contextual input 310 can be for example, active listening 312, or other sensory data. For example, other sensory data can be location based information 314 from, for example, Global Positioning System data or other location based information. Other sensory data, can be certain other environment based sensory information that provided on a sensor 316, such as temperature, movement, humidity, etc in the clouds. The first contextual input module 332 can be configured similar to the second contextual input module 310.

Various other sensory data can be inputted from either sensors on the mobile device 320 or sensors 316 that are located outside the mobile device 320. The sensors 316 can provide, for example, the sensory information wirelessly to the cloud-based server 322.

Other variations are also possible. Additionally, other implementations of the clouds are provided further in this disclosure.

Referring back to FIG. 1, a user can input 102 a search term in a search bar, and upon entering the i^{th} character (where i is an integer greater than or equal to zero), on the display 150 a search bar drop-down is provided displaying a list of suggestions which include those based on key-phrase generation at the parsing and context aware key-word generation module 106. Therefore, the output as seen in the display 150 is autocomplete suggestions which include any contextual matches to key-phrases. These autocomplete suggestions can also be enabled in the clouds as seen in the examples of FIGS. 2 and 3.

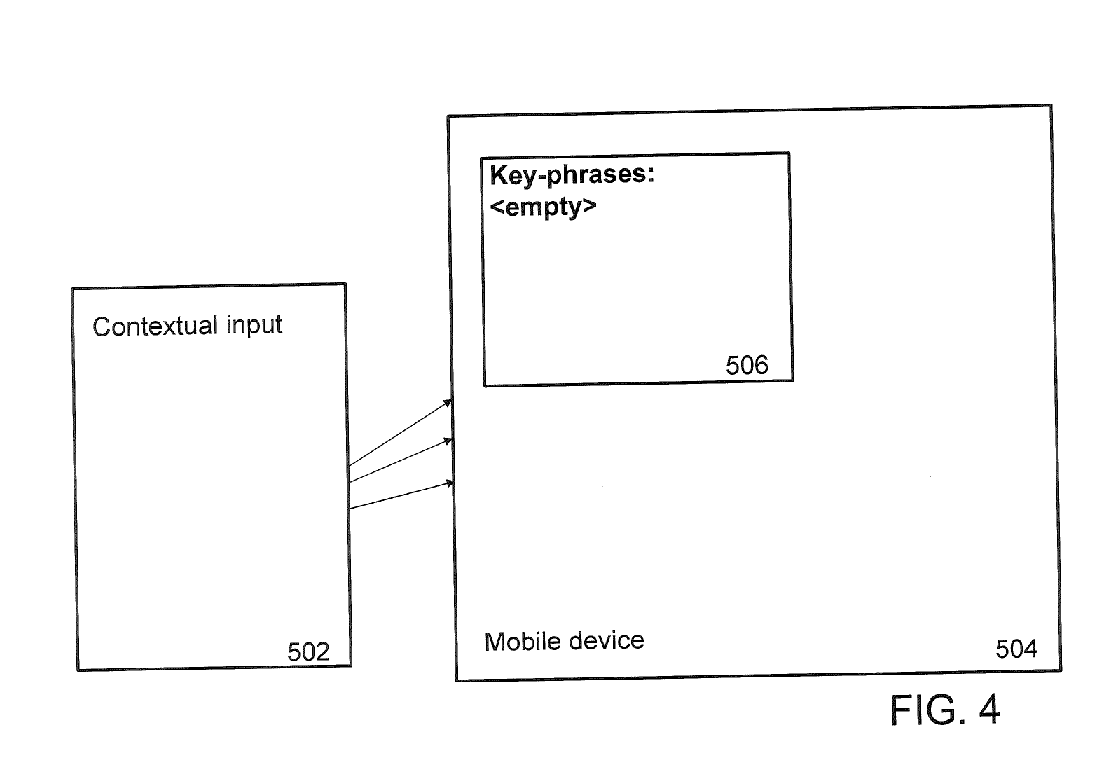

Referring to FIG. 4, an example of contextual input capture is provided. The contextual input 502 can be, for example, audio capture:

“The Empire State Building is pretty tall.

“Is that the tallest in New York?”

“I think so.”

“What about One World Trade Center?”

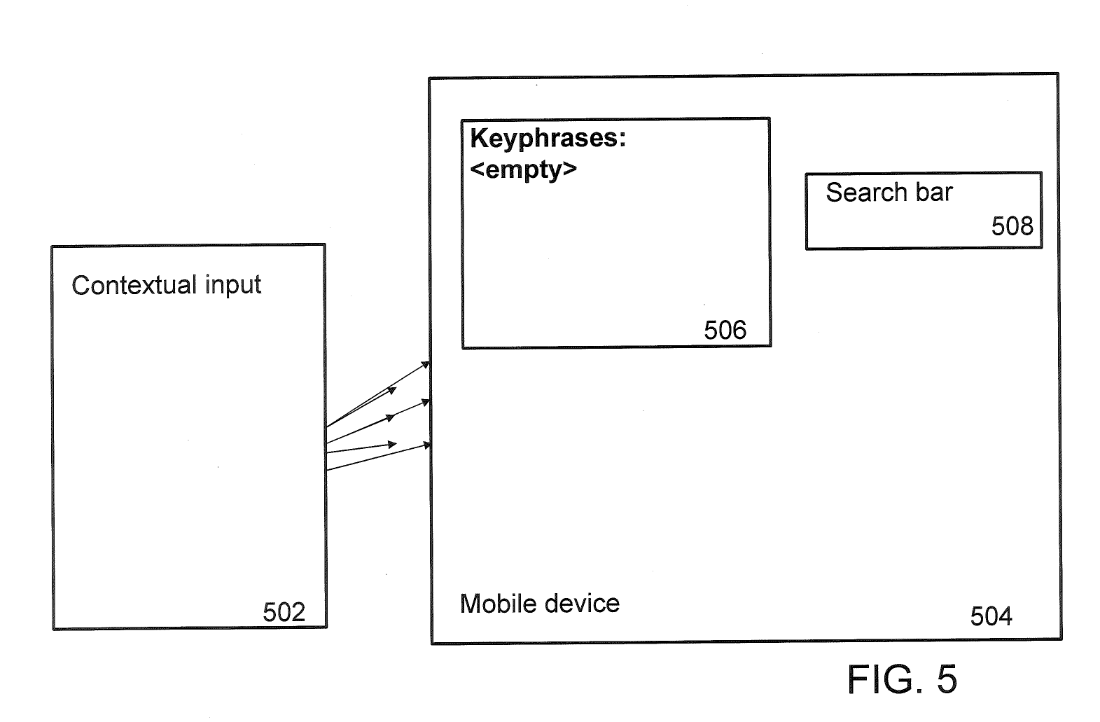

Initially, the Key-phrases 506 can be displayed as empty. However, as seen in FIG. 5, when a user opens a search bar 608, the mobile device 604 can initiate a key-word generation.

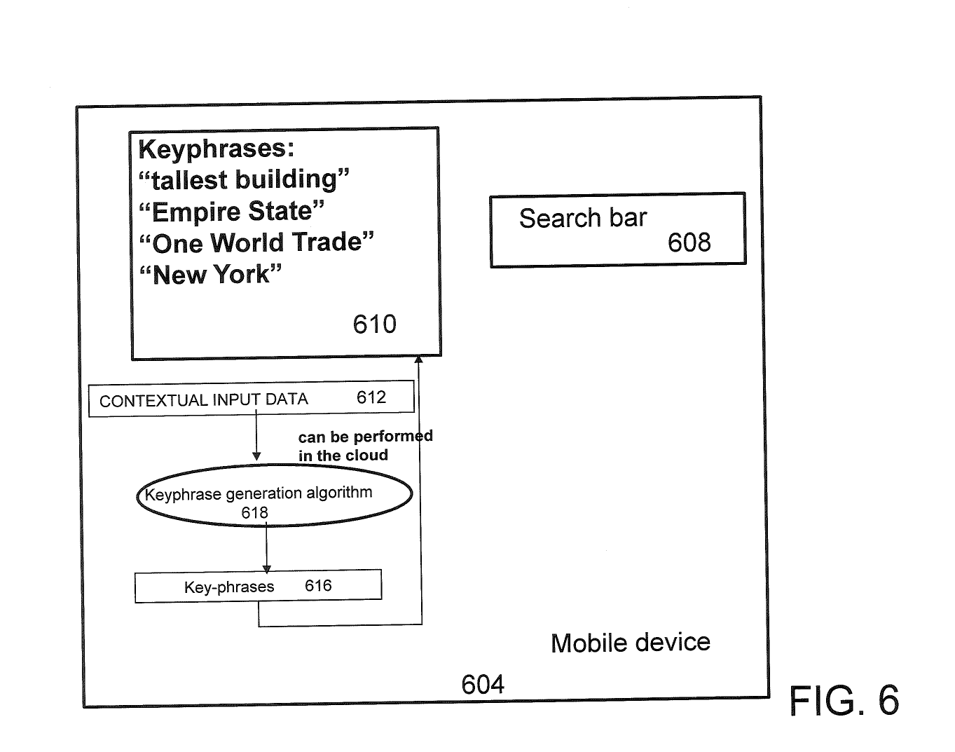

Referring to FIG. 6, a key-phrase generation can be made locally in the mobile device 604 or in the clouds. Here, the key-phrases 610 includes “tallest building”, “Empire State”, “One World Trade”, “New York”, which is initiated by the search bar 608. The contextual input data 612 is sent into the key-phrase algorithm 618 (which can also be performed in the clouds rather than in the mobile device 604) to generate the key-phrases 616. The key-phrases are then displayed in the key-phrase display 610.

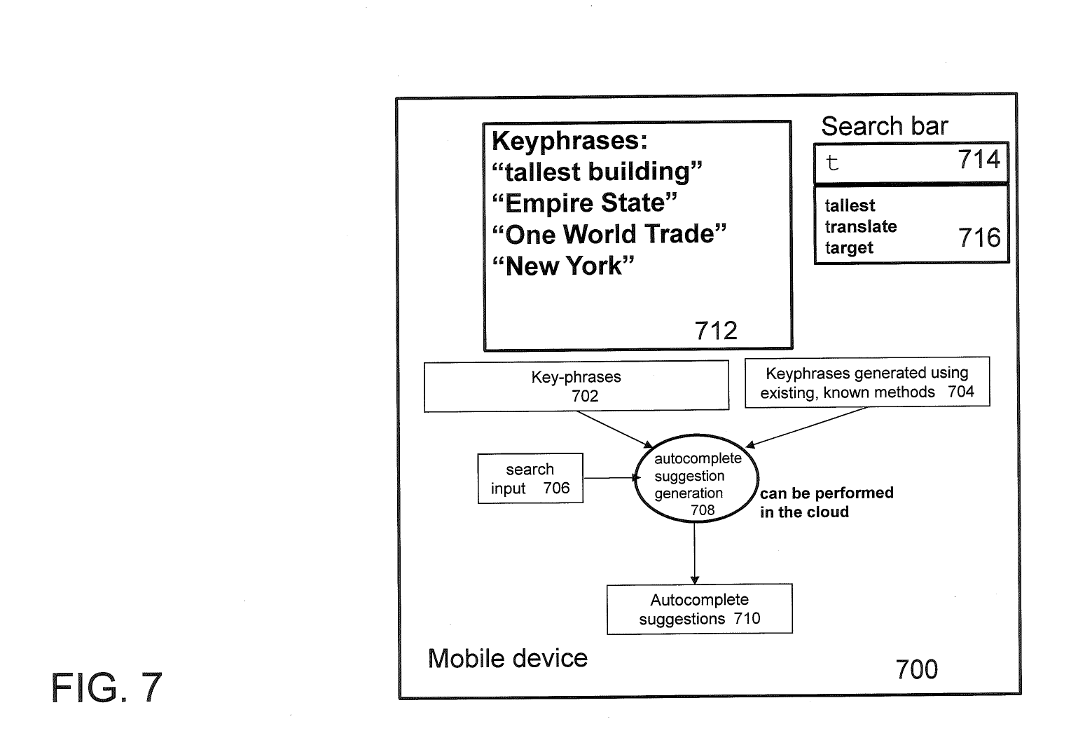

FIG. 7 illustrates an example of when a user enters input into the search bar. The user enters “t” in the search bar 714, which drops down to a list of “tallest”, “translate”, and “target” in the search bar drop down display 716. The key-phrases generated at display 712 are “tallest building”, “Empire State”, “One World Trade”, “New York”.

Therefore, The autocomplete suggestion generation 708 inputs the search input 706 at the search bar 714, the key-phrases generated by the disclosed invention 702, key-phrases generated using existing, known methods 704 to generate the auto-complete suggestions 710 at mobile device 700 or in the clouds. Therefore, the auto-complete suggestions 710 are Autocomplete suggestions: tallest (taken key-phrase generation of contextual input), translate (taken from autocomplete suggestion from existing method), target (taken from autocomplete suggestion from existing method) as seen in the search bar drop down display 716. The key-phrases generated by the disclosed invention 702 can be generated, for example, by the parsing and context-aware key-word generation 106 as seen in FIG. 1.

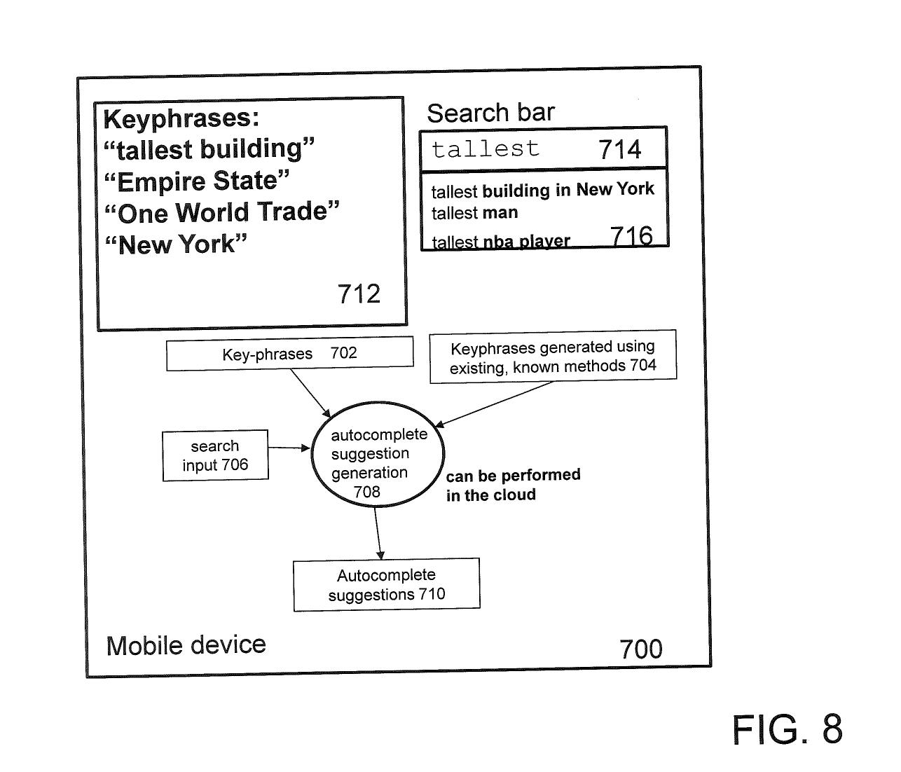

FIG. 8 illustrates another example of a user entering the search bar 714. Here, the user continues to input to the search bar 714 the complete word: “tallest”. The autocomplete suggestions are: tallest building in New York (taken key-phrase generation of contextual input), tallest man (taken from autocomplete suggestion from existing method); tallest NBA player (taken from autocomplete suggestion from existing method.

The autocomplete suggestions 710 take into account all the different inputs, instead of merely the search bar entry. The search input 706, key-phrases generated by the disclosed invention 702, and also key-phrases generated using existing known methods 704 is inputted into the autocomplete suggestion generation unit 708 to provide the final more complete autocomplete suggestions 710.

In a special case, suggestions can be displayed in a drop-down when the search bar is opened, with zero characters entered, based on key-phrase generation of contextual input.

### Exemplary Hardware and Cloud Implementation

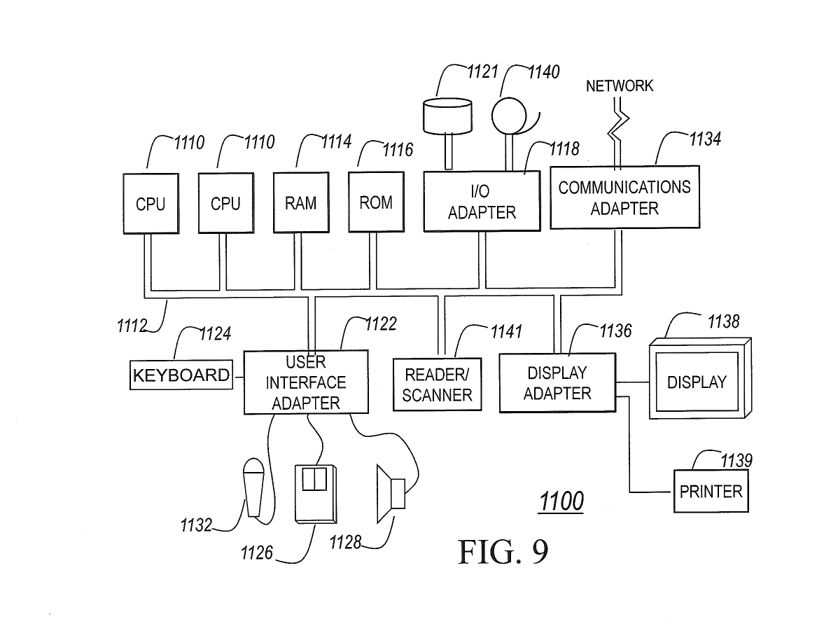

FIG. 9 illustrates another hardware configuration of an information handling/computer system 1100 in accordance with the disclosed invention and which preferably has at least one processor or central processing unit (CPU) 1110 that can implement the techniques of the invention in a form of a software program.

The CPUs 1110 are interconnected via a system bus 1112 to a random access memory (RAM) 1114, read-only memory (ROM) 1116, input/output (I/O) adapter 1118 (for connecting peripheral devices such as disk units 1121 and tape drives 1140 to the bus 1112), user interface adapter 1122 (for connecting a keyboard 1124, mouse 1126, speaker 1128, microphone 1132, and/or other user interface device to the bus 1112), a communication adapter 1134 for connecting an information handling system to a data processing network, the Internet, an Intranet, a personal area network (PAN), etc., and a display adapter 1136 for connecting the bus 1112 to a display device 1138 and/or printer 1139 (e.g., a digital printer or the like).

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, comprising signal-bearing storage media tangibly embodying a program of machine-readable instructions executable by a digital data processor incorporating the CPU 1110 and hardware above, to perform the method of the invention.

This signal-bearing storage media may include, for example, a RAM contained within the CPU 1110, as represented by the fast-access storage for example.

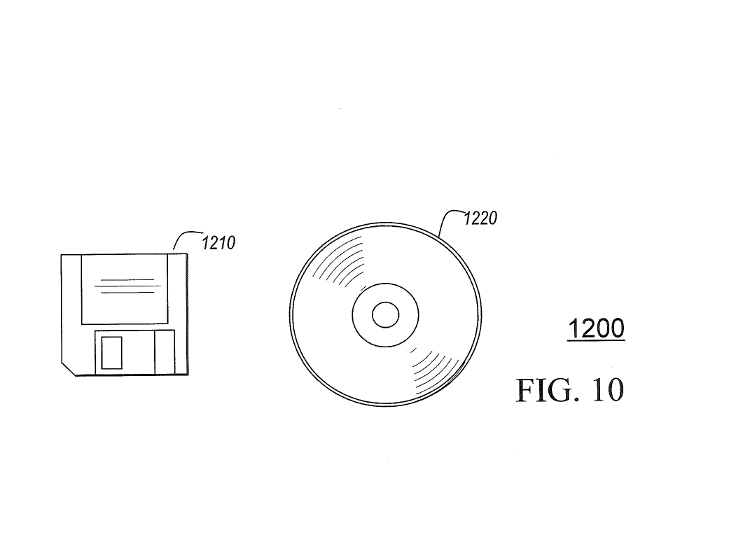

Alternatively, the instructions may be contained in another signal-bearing storage media 1200, such as a magnetic data storage diskette 1210 or optical storage diskette 1220 (FIG. 10), directly or indirectly accessible by the CPU 1210.

Whether contained in the diskette 1210, the optical disk 1220, the computer/CPU 1210, or elsewhere, the instructions may be stored on a variety of machine-readable data storage media.

Therefore, the present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

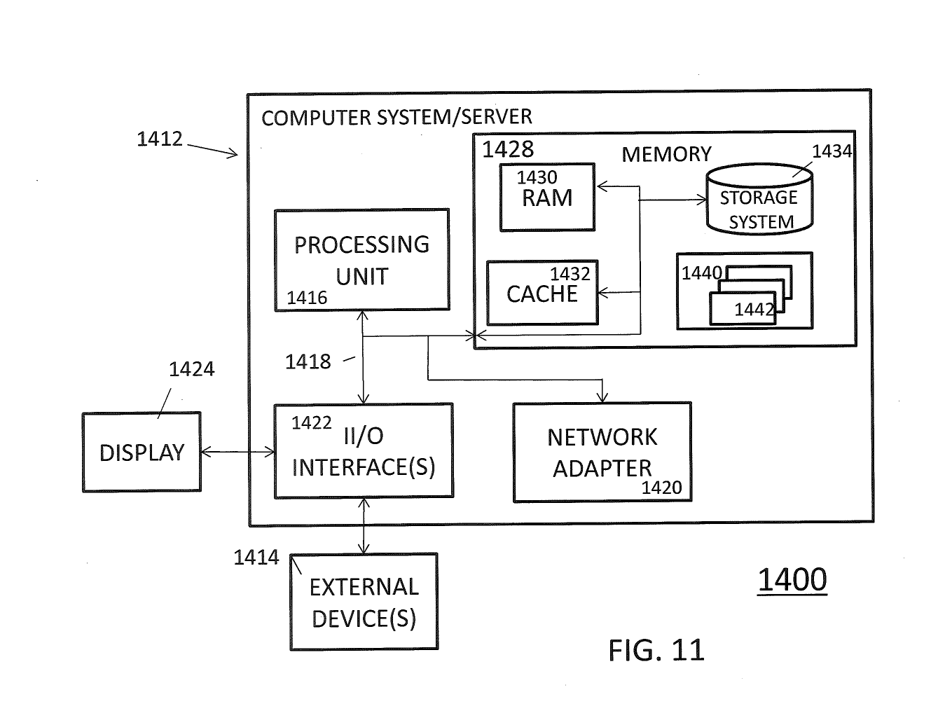

Referring now to FIG. 11, a schematic 1400 of an example of a cloud computing node is shown. Cloud computing node 1400 is only one example of a suitable cloud computing node and is not intended to suggest any limitation as to the scope of use or functionality of embodiments of the invention described herein. Regardless, cloud computing node 1400 is capable of being implemented and/or performing any of the functionality set forth hereinabove.

In cloud computing node 1400 there is a computer system/server 1412, which is operational with numerous other general purpose or special purpose computing system environments or configurations. Examples of well-known computing systems, environments, and/or configurations that may be suitable for use with computer system/server 1412 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 1412 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 1412 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 11, computer system/server 1412 in cloud computing node 1400 is shown in the form of a general-purpose computing device. The components of computer system/server 1412 may include, but are not limited to, one or more processors or processing units 1416, a system memory 1428, and a bus 1418 that couples various system components including system memory 1428 to processor 1416.

Bus 1418 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 1412 typically includes a variety of computer system readable media. Such media may be any available media that is accessible by computer system/server 1412, and it includes both volatile and non-volatile media, removable and non-removable media.

System memory 1428 can include computer system readable media in the form of volatile memory, such as random access memory (RAM) 1430 and/or cache memory 1432. Computer system/server 1412 may further include other removable/non-removable, volatile/non-volatile computer system storage media. By way of example only, storage system 1434 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1418 by one or more data media interfaces. As will be further depicted and described below, memory 1428 may include at least one program product having a set (e.g., at least one) of program modules that are configured to carry out the functions of embodiments of the invention.

Program/utility 1440, having a set (at least one) of program modules 1442, may be stored in memory 1428 by way of example, and not limitation, as well as an operating system, one or more application programs, other program modules, and program data. Each of the operating system, one or more application programs, other program modules, and program data or some combination thereof, may include an implementation of a networking environment. Program modules 1442 generally carry out the functions and/or methodologies of embodiments of the invention as described herein.

Computer system/server 1412 may also communicate with one or more external devices 1414 such as a keyboard, a pointing device, a display 1424, etc.; one or more devices that enable a user to interact with computer system/server 1412; and/or any devices (e.g., network card, modem, etc.) that enable computer system/server 1412 to communicate with one or more other computing devices. Such communication can occur via Input/Output (I/O) interfaces 1422. Still yet, computer system/server 1412 can communicate with one or more networks such as a local area network (LAN), a general wide area network (WAN), and/or a public network (e.g., the Internet) via network adapter 1420. As depicted, network adapter 1420 communicates with the other components of computer system/server 1412 via bus 1418. It should be understood that although not shown, other hardware and/or software components could be used in conjunction with computer system/server 1412. Examples, include, but are not limited to: microcode, device drivers, redundant processing units, external disk drive arrays, RAID systems, tape drives, and data archival storage systems, etc.

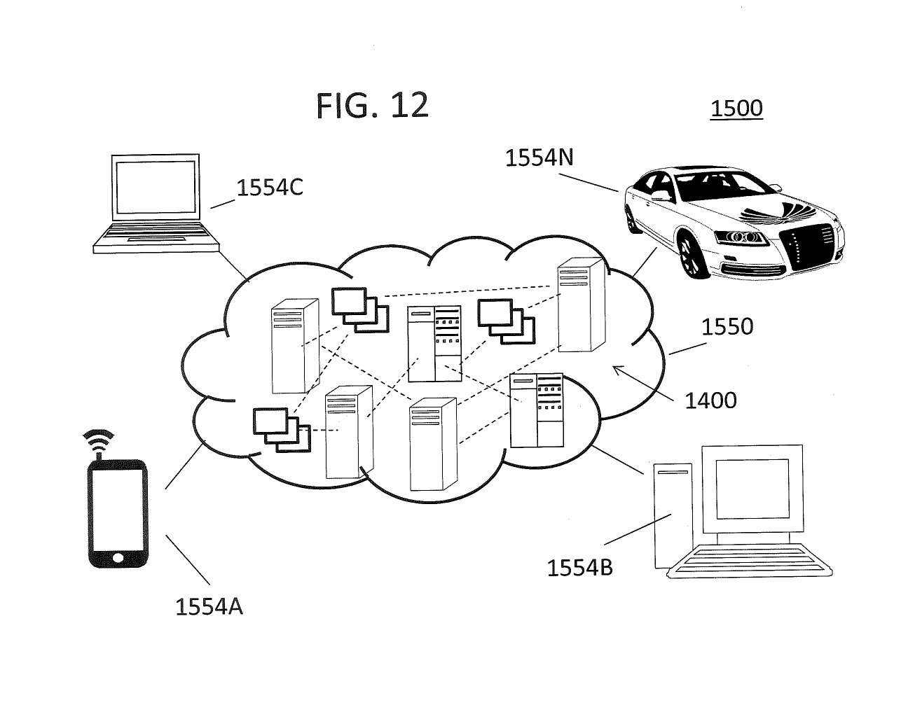

Referring now to FIG. 12, illustrative cloud computing environment 1550 is depicted. As shown, cloud computing environment 1550 comprises one or more cloud computing nodes 1400 with which local computing devices used by cloud consumers, such as, for example, personal digital assistant (PDA) or cellular telephone 1554A, desktop computer 1554B, laptop computer 1554C, and/or automobile computer system 1554N may communicate. Nodes 1400 may communicate with one another. They may be grouped (not shown) physically or virtually, in one or more networks, such as Private, Community, Public, or Hybrid clouds as described hereinabove, or a combination thereof. This allows cloud computing environment 1550 to offer infrastructure, platforms and/or software as services for which a cloud consumer does not need to maintain resources on a local computing device. It is understood that the types of computing devices 1554A-N shown in FIG. 12 are intended to be illustrative only and that computing nodes 1400 and cloud computing environment 1550 can communicate with any type of computerized device over any type of network and/or network addressable connection (e.g., using a web browser).

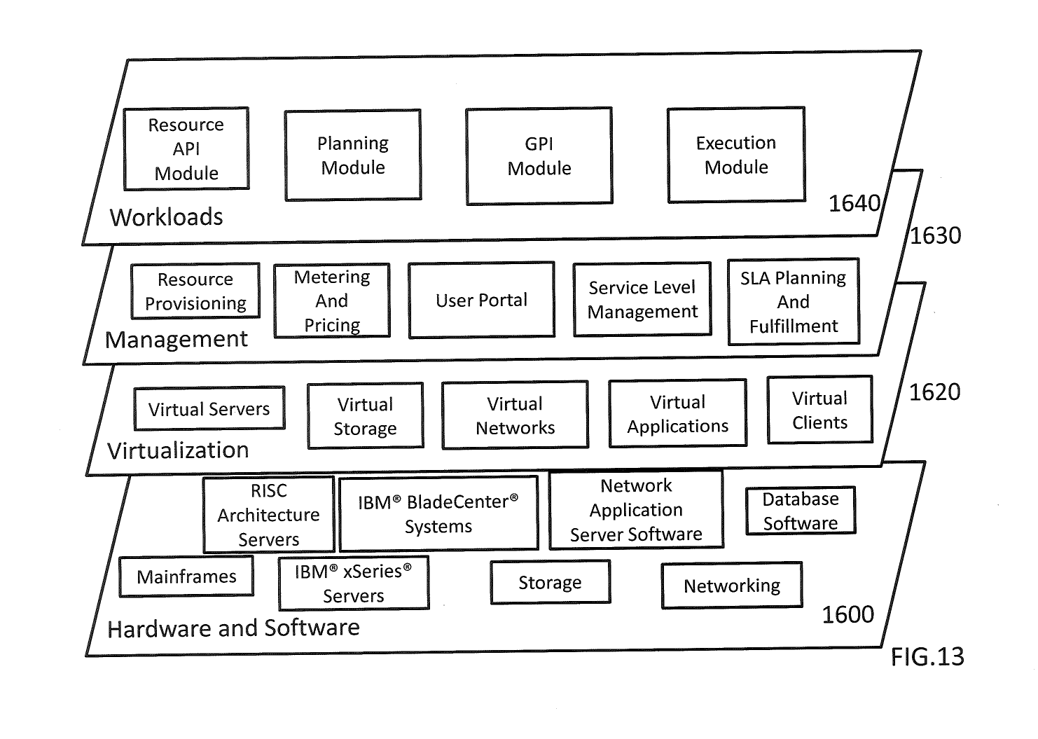

Referring now to FIG. 13, a set of functional abstraction layers provided by cloud computing environment 1550 (FIG. 12) is shown. It should be understood in advance that the components, layers, and functions shown in FIG. 13 are intended to be illustrative only and embodiments of the invention are not limited thereto. As depicted, the following layers and corresponding functions are provided:

Hardware and software layer 1660 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 1662 provides an abstraction layer from which the following examples of virtual entities may be provided: virtual servers; virtual storage; virtual networks, including virtual private networks; virtual applications and operating systems; and virtual clients.

In one example, management layer 1664 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 1666 provides examples of functionality for which the cloud computing environment may be utilized. Examples of workloads and functions which may be provided from this layer include such functions as mapping and navigation; software development and lifecycle management; virtual classroom education delivery; data analytics processing; transaction processing; and, more particularly relative to the disclosed invention, the APIs and run-time system components of generating search autocomplete suggestions based on contextual input.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A mobile device, comprising:
a key-information generator receiving contextual input, and parsing the received contextual input to generate a plurality of suggestions,
wherein the key-information generator parses via analyzing the contextual input into parts to generate for output, the plurality of suggestions based on the contextual input.

2. The mobile device according to claim 1, further comprising an autocomplete suggestion generator that receives the suggestions generated by the key-information generator, a search input, and a second set of suggestions generated using another method than the key-information generator to provide autocomplete suggestions.

3. The mobile device according to claim 1, further comprising:
a processor; and
a computer readable medium storing a program executable by the processor, including the key-information generator.

4. The mobile device according to claim 1, wherein upon a trigger, a list of suggestions is generated by the key-information generator based on analysis of contextual information.

5. The mobile device according to claim 1, wherein the contextual information includes audio data for a time frame in a range of 5 seconds to 2 minutes.

6. The mobile device according to claim 1, wherein the contextual information includes data from sensors, the data including location information, environmental condition, and health information.

7. The mobile device according to claim 1, further comprising a display receiving the plurality of suggestions from the key-information generator,
wherein the display provides a search bar drop-down, displaying a list of suggestions which include those based on the suggestions generated by the key-information generator.

8. The mobile device according to claim 1, further comprising an autocomplete suggestion generator receiving input from the key-information generator, another key-information generator and a search input to generate a plurality of autocomplete suggestions, and
wherein the suggestions include key-words, key-phrases, images, video, and direct search of sensory data.

9. A search system, comprising:
a memory;
a processor coupled to the memory; and
a key-word generator module that is coupled with the memory and the processor configured to perform a method comprising:
receiving, by the key-word generator module, contextual input;
parsing via analyzing the contextual input into parts; and
generating a plurality of suggestions based on the contextual input for output.

10. The search system according to claim 9, further comprising an autocomplete suggestion generator that receives the plurality of suggestions generated by the key-word generator, a search input, a second set of suggestions generated using another method than the key-word generator to provide autocomplete suggestions for the output.

11. The search system according to claim 10, wherein the autocomplete suggestion generator and autocomplete generator being implemented in a cloud computing system.

12. The search system according to claim 9, further comprising:
a computer readable medium storing a program executable by a processor, including the key-phrase generator being implemented in a cloud computing system.

13. The search system according to claim 9, wherein upon a trigger, a list of suggestions is generated by the key-word generator based on analysis of contextual information.

14. The search system according to claim 9, wherein the contextual information includes audio data for a time frame in a range of 5 seconds to 2 minutes.

15. The search system according to claim 9, wherein the contextual information includes data from sensors, the data including location information, environmental condition, and health information.

16. The search system according to claim 9, wherein the system further includes a mobile device including a display receiving the plurality of suggestions from the key-word generator, and
wherein the display in the mobile device provides a search bar drop-down, displaying a list of suggestions which include those based on key-phrase generation.

17. A computer program product comprising a computer readable storage medium having program instructions embodied therewith, the program instructions readable and executable by a computer to cause the computer to:
receiving contextual input;
parsing the contextual input via analyzing the contextual input into parts; and
generating a plurality of suggestions based on the contextual input; and
outputting the generated plurality of suggestions.

18. The computer program product according to claim 17, further comprises generating autocomplete suggestions according to the plurality of suggestions generated, a search input, and key-phrases generated using another method
wherein the generated autocomplete suggestions being outputted on a mobile device.

19. The computer program product according to claim 18, further comprising:
storing a program on a computer-readable medium executable by a processor, including the key-phrase generator.

20. The computer program product according to claim 17, wherein the contextual information includes data from sensors, the data including location information, environmental condition, and health information, and
further comprising of outputting a search bar drop-down having a list of suggestions which include those based on key-phrase generation.
